(19) United States
(12) Patent Application Publication
(10) Pub. No.: US 2026/0326805 A1
(43) Pub. Date: Oct. 22, 2026

(54) RACK MOVER

(71) Applicant: JAVIER LOPEZ, YORBA LINDA, CA (US)

(72) Inventor: JAVIER LOPEZ, YORBA LINDA, CA (US)

(21) Appl. No.: 19/186,236

(22) Filed: Apr. 22, 2025

(51) Int. Cl. B62B 5/00; B62B 1/14

(52) U.S. Cl. CPC B62B 5/0093; B62B 1/14; B62B 5/0086

(57) ABSTRACT

The rack mover system has a caster. The caster has a tine support extending upwardly above a caster platform. The caster platform receives a caster wheel. The tine support supports a pair of tines extending laterally from the tine support. The pair of tines include a caster upper tine and a caster lower tine. A rack has a rack leg. The caster upper tine is configured to extend into the rack leg at an upper retainer opening. The caster lower tine is configured to extend into the rack leg at a lower retainer opening. A caster swivel receives the caster wheel on a wheel axle. The caster swivel is mounted to the caster platform. The lifting lever has a prong plate with a first lifting prong and a second lifting prong.

### FIELD OF THE INVENTION

The present invention is in the field of rack movers.

### DISCUSSION OF RELATED ART

A variety of different rack movers have been discussed in United States patents. For example, in U.S. Pat. No. 12,221,148 entitled, “Four Position Hand Truck,” by Jose Angel Caceres Mendoza, published Feb. 11, 2025, the inventor describes, “A hand truck includes a frame that is supported by main wheels and a handle having two side members. Two handle brackets are pivotably mounted on opposite sides of the frame. The handle brackets are arranged for rotation in relation to the frame around a handle rotation axis. The handle brackets slidably receive the side members of the handle so that the handle is able to slide between a first retracted position and a second extended position. The handle is also able to rotate with the handle brackets between first and second rotational positions. A lock mechanism that is mechanically associated with the handle brackets and the handle is able to releasably lock the degree of extension of the handle in at least one position between the retracted and extended positions and is able to lock the rotational position of the handle in at least one rotational position.”

For example, in U.S. Pat. No. 11,840,269 entitled, “Hand Truck,” by Yaron Brunner, Izhar Shany, and Uri Parizer, published Dec. 12, 2023, the inventors describe, “Provided is a hand truck comprising a frame having a first end, and a second end configured with a wheel set, and a ledge extending at said second end, wherein one or both of the frame and the ledge is configured with an articulation arrangement for detachably attaching thereto a utility unit, the articulation arrangement extending parallel to a plane of the respective frame or ledge.”

For example, in U.S. Pat. No. 11,613,290 entitled, “Hand Truck System,” by Peter Michael Greenup, published Mar. 28, 2023, the inventor describes, “A hand-truck frame system includes a main frame, a bed frame, and pair of multi-wheel assembles coupled to the main frame and rotatable to provide improved climbing capabilities over certain terrain, such as stairs. The multi-wheel assemblies can have four wheels radially mounted about respective hubs of the first and second multi-wheel assemblies.”

For example, in U.S. Pat. No. 11,878,726 entitled, “Handcart,” by Yoshinori Shibata, Susumu Kato, Tomonobu Nashimoto, Kohei Oishi, and Yasuo Ifuku, published Jan. 23, 2024, the inventors describe, “A handcart may include a chassis unit and a container unit configured to be detachably attached to the chassis unit. The chassis unit may include a front wheel unit rotatably supporting a front wheel; a rear wheel unit rotatably supporting a rear wheel; a chassis frame extending in a front-rear direction and supporting the front and rear wheel units; and a prime mover configured to rotate at least one of the front wheel and the rear wheel as a drive wheel. The container unit may be selected from a group including at least a first container unit and a second container unit. The first container unit may include a first container and a first container frame extending in the front-rear direction and supporting the first container. The second container unit may include a second container and a second container frame extending in the front-rear direction and supporting the second container.”

For example, in U.S. Pat. No. 9,211,894 entitled, “Load Carrier with Mode Changer” by William R Gibson, published Dec. 15, 2015, the inventor describes, “A multi-mode load carrier is convertible to assume a storage mode, a cart mode, and a hand-truck mode. The load carrier includes a rolling base and a base pusher having a handgrip.”

For example, in U.S. Pat. No. 8,465,046 entitled, “Convertible Hand Truck” by Paul F Meyers and Thomas J Meyers, published Jun. 18, 2013, the inventors describe, “A multi-mode hand truck is convertible to assume a hand-truck mode, a reclined load-assist mode, and a push-cart mode.”

For example, in U.S. Pat. No. 7,641,011 entitled, “Pallet Jack Having Width-Adjustable Fork Prongs,” by Weith Wayne Fridlington, Jr. and Keith Wayne Fridlington, Sr., published Jan. 5, 2010, the inventors describe, “A pallet jack includes a frame and a pair of outwardly projecting load prongs connected to the frame. The proximal ends of the prongs are connected to a horizontal member on the rear of the frame by brackets that keep the prongs out of the frame proper. A threaded rod is mounted horizontally on the horizontal member and is threaded into the proximal end of each prong, with the two ends of the threaded rod having opposite hand threads. The threaded rod is rotated by a user turning a crank mounted on top of the frame and connected to the adjustment threaded rod by a chain drive, allowing the width between the prongs to be adjusted inwardly or outwardly.”

For example, in U.S. Pat. No. 10,407,087 entitled, “Vehicle Door Removal and Storage Dolly,” by Bob Baker and Jenea Law, published Sep. 10, 2019, the inventors describe, “A vehicle door removal and storage dolly using a height controllable upper frame with side extending door support platforms that allows the vehicle doors to be positioned both vertically and horizontally for installation and removal from a vehicle. The extending door platforms are planarly aligned for a compacted position and include padded vertical door supports for supporting the vehicle doors during storage periods.”

For example, in U.S. Pat. No. 11,597,419 entitled, “Modular Pallet Jack,” by Dane Gin Mun Kalinowski and Philip A. King, published Mar. 7, 2023, the inventors describe, “A lift for a fork tine assembly includes a generally upright frame having at least one handle grip portion at a rearward portion thereof. The handle grip portion is fixed relative to the frame. A lift mechanism is secured to the frame. The lift mechanism is capable of attaching to and raising and lowering at least one fork tine. A plurality of wheels support the frame. The at least one fork tine may be part of a first fork tine assembly that can be selectively removed from the lift and replaced with a different configuration fork tine assembly. An optional shelf is provided on the frame for convenience but may be pivoted out of the way when not in use.”

### SUMMARY OF THE INVENTION

The rack mover system has a caster. The caster has a tine support extending upwardly above a caster platform. The caster platform receives a caster wheel. The tine support supports a pair of tines extending laterally from the tine support. The pair of tines include a caster upper tine and a caster lower tine. A rack has a rack leg. The caster upper tine is configured to extend into the rack leg at an upper retainer opening. The caster lower tine is configured to extend into the rack leg at a lower retainer opening.

A caster swivel receives the caster wheel on a wheel axle. The caster swivel is mounted to the caster platform. The lifting lever has a prong plate with a first lifting prong and a second lifting prong. The first lifting prong and the second lifting prong are configured to lift the rack leg at a rack crossbeam. A caster bucket has a lifting lever slot. The lifting lever slot receives the lifting lever. The lifting lever is configured to bias the caster bucket to roll on a right bucket wheel and a left bucket wheel when a user pulls back on the lifting lever. The right bucket wheel and the left bucket wheel are mounted to the caster bucket.

The lifting lever slot is a middle slot is formed between the right bucket holder and the left bucket holder. The lifting lever further includes a bending plate. The bending plate is welded above the lifting lever handle. The bending plate is parallel to the lifting lever handle. The bending plate extends from the lifting lever handle to a riser. The first lifting prong is distal to the second lifting prong. The first lifting prong is shorter than the second lifting prong.

The scoop caster has a first scoop caster wheel, a second scoop caster wheel, and a third scoop caster wheel. The first scoop caster wheel is mounted in a first wheel cavity. The second scoop caster wheel is mounted in a second wheel cavity. The third scoop caster wheel is mounted in a third wheel cavity. A scoop caster platform is formed between the third wheel cavity and the second wheel cavity. The first wheel cavity is adjacent to the second wheel cavity and the third wheel cavity.

The first wheel cavity is formed between a first wheel cavity right sidewall and a first wheel cavity left sidewall. The second wheel cavity is formed between a second wheel cavity rear sidewall and a second wheel cavity front sidewall. The third wheel cavity is formed between a third wheel cavity rear sidewall and a third wheel cavity front sidewall. The scoop caster platform is formed between a third wheel cavity proximal sidewall, a second wheel cavity proximal sidewall, and a first wheel cavity proximal sidewall. The first wheel cavity proximal sidewall defines a proximal sidewall of the first wheel cavity. The second wheel cavity proximal sidewall defines a proximal sidewall of the second wheel cavity. The third wheel cavity proximal sidewall defines a proximal sidewall of the third wheel cavity.

The rack mover system has a scoop caster hand truck. The scoop caster hand truck has a hand truck handle for lifting a lifter plate. The lifter plate has a first lifter plate rail and a second lifter plate rail. The first lifter plate rail and the second lifter plate rail define a lifter plate retainer channel along the lifter plate. The lifter plate further includes a lifter plate front support. The lifter plate front support is formed as an extending edge.

### BRIEF DESCRIPTION OF THE DRAWINGS

FIG. 1 is a diagram showing a lifting lever.

FIG. 2 is a diagram showing a Caster side view.

FIG. 3 is a diagram showing a caster bottom view.

FIG. 4 is a diagram showing a lifting lever.

FIG. 5 is a diagram showing a caster bucket.

FIG. 6 is a diagram showing a lifting lever engaged to the caster bucket.

FIG. 7 is a diagram showing a rack.

FIG. 8 is a diagram showing a caster engaging a rack.

FIG. 9 is a diagram showing a scoop caster bottom view.

FIG. 10 is a diagram showing a scoop caster perspective view.

FIG. 11 is a diagram showing a hand truck configured to retain the scoop casters.

The following call out list of elements can be a useful guide for referencing the element numbers of the drawings.
20 lifting lever
21 lifting lever handle
22 bending plate
23 bending plate weld
24 fulcrum foot
25 riser
26 first lifting prong
27 second lifting prong
28 prong plate
29 riser tip
30 caster
31 caster platform
32 caster wheel
33 wheel swivel
34 wheel axle
35 cater upper tine
36 caster lower tine
37 tine support
38 abutment face
39 platform weld
41 upper tine height
42 upper tine width
43 lower tine height
44 lower tine width
45 caster base plate
46 caster connector
46 caster wheel bearing surface
47 caster offset
48 tine rib
49 support angle
50 caster bucket
51 right bucket holder
52 left bucket holder
53 right bucket wheel
54 left bucket wheel
55 opening plate
56 middle slot
57 front panel
58 back bracket
59 back bracket tab
61 upper bucket opening
62 lower bucket opening
63 right panel
64 left panel
65 rear panel
66 bottom panel
67 rear panel back notch
69 shelf mount openings
80 rack system
81 lower retainer opening
82 upper retainer opening
83 rack foot
84 rack foot tab
85 rack cross beam
86 rack leg
87 rectangular profile
88 rack
70 scoop caster
71 first scoop caster wheel
72 second scoop caster wheel
73 third scoop caster wheel
74 scoop caster platform
75 first wheel cavity
76 second wheel cavity
77 third wheel cavity
78 platform
79 scoop caster platform rear portion
91 second wheel cavity front sidewall
92 third wheel cavity front sidewall
93 second wheel cavity rear sidewall
94 third wheel cavity rear sidewall
95 first wheel cavity left sidewall
96 first wheel cavity right sidewall
97 second wheel cavity proximal sidewall
98 third wheel cavity proximal side wall
99 first wheel cavity proximal sidewall
100 scoop caster hand truck
101 lifter plate
102 lifter plate front support
103 second lifter plate rail
104 first lifter plate rail
105 lifter plate retainer channel
106 lifter plate rail connection
107 hand truck wheel
108 hand truck handle

### DETAILED DESCRIPTION OF THE PREFERRED EMBODIMENT

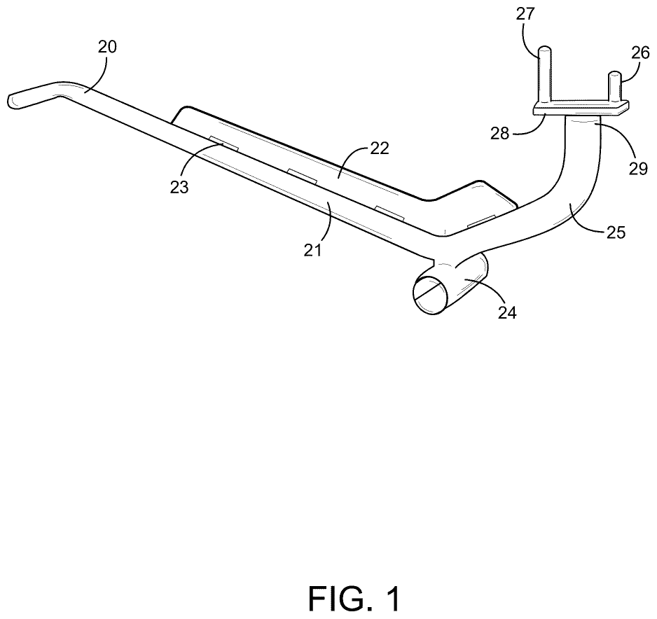

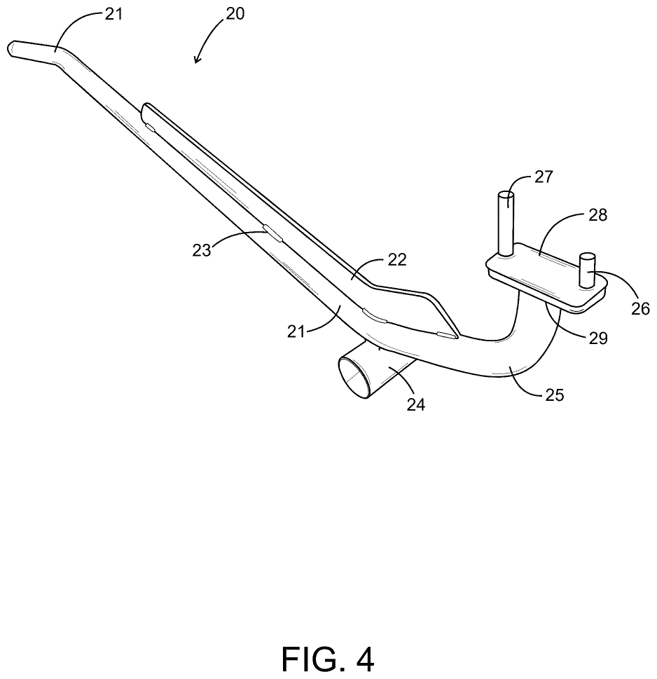

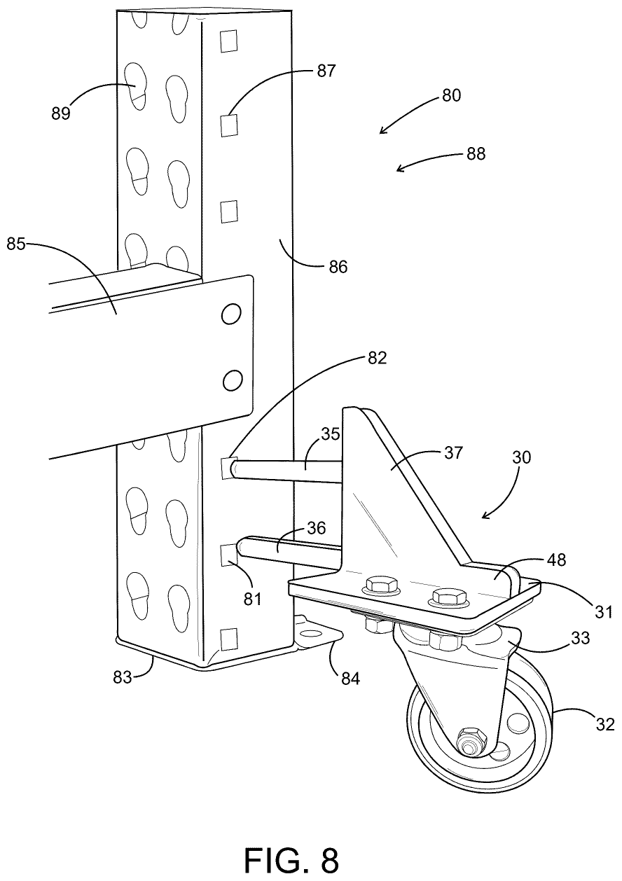

As seen in FIGS. 1 and 4, a diagram of a lifting lever 20 has a lifting lever handle 21 that extends outwardly towards a user. The user can press down on the lifting lever handle 21. The lifting lever handle 21 is welded to a fulcrum foot 24 and extends to a riser 25. The riser 25 terminates at a riser tip 29. The fulcrum foot 24 can be a transverse tube welded to the lifting lever handle 21 and the riser 25. The first lifting prong 26 and the second lifting prong 27 extend upwardly from a prong plate 28. The prong plate 28 is welded to the riser tip 29, and the first lifting prong 26 and the second lifting prong 27 are welded to the prong plate 28. Preferably, a bending plate 22 extends from the lifting lever handle 21 to the riser 25. The bending plate 22 is preferably welded to the lifting lever 20 at a plurality of bending plate welds 23. As seen in FIG. 8, the lifting prongs can lift up a rack by a rack cross beam 85 when the rack 88 is unloaded. Then the caster 30 can be inserted.

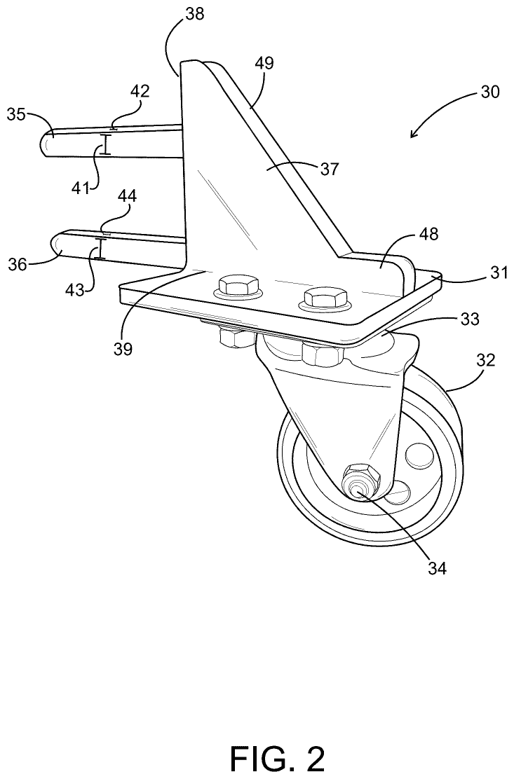

As seen in FIG. 2, the caster 30 has a caster platform 31 connected to a wheel swivel 33. The wheel swivel 33 works with the caster wheel 32. The caster wheel 32 rotates on a wheel axle 34. The caster wheel 32 and wheel swivel 33 can be replaced occasionally as necessary. The caster platform 31 connects to a tine support 37 at a platform weld 39. The tine support 37 has a support angle 49 that terminates at a time rib 48. The abutment face 38 of the tine support 37 preferably abuts the rack 88 of the rack system 80. The abutment face 38 is perpendicular to the caster platform 31 and the platform weld 39. The tine support 37 supports a pair of extensions, namely a caster upper tine 35 and a caster lower tine 36. The caster upper tine 35 has an upper tine width 42 that is greater than an upper tine height 41. Similarly, the caster lower tine 36 preferably has a lower tine width 44 that is greater than a lower tine height 43.

The pair of times extend into the rack and support the rack above the floor so that the user can move the rack around.

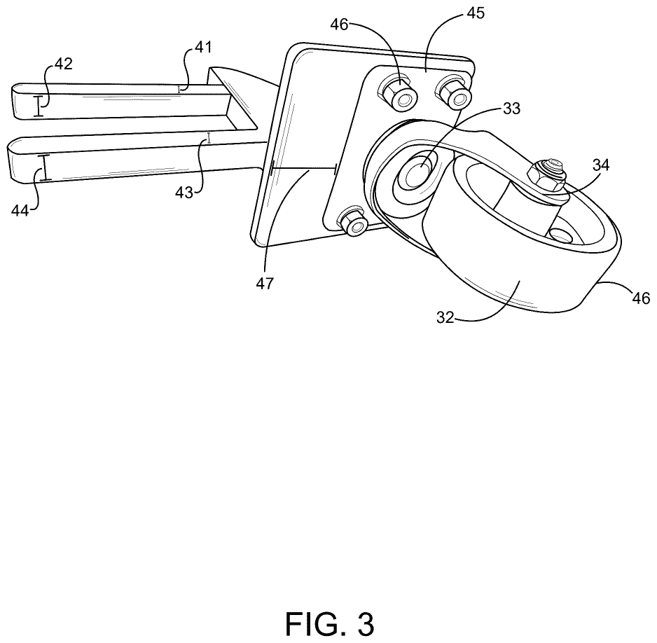

As seen in FIG. 3, the caster wheel 32 has a caster wheel bearing surface 46 that is preferably elastomeric. The wheel axle 34 of the caster wheel 32 is preferably perpendicular to the wheel swivel 33. The caster base plate 45 has a caster offset 47 from an edge of the caster platform 31 near the side of the abutment face 38.

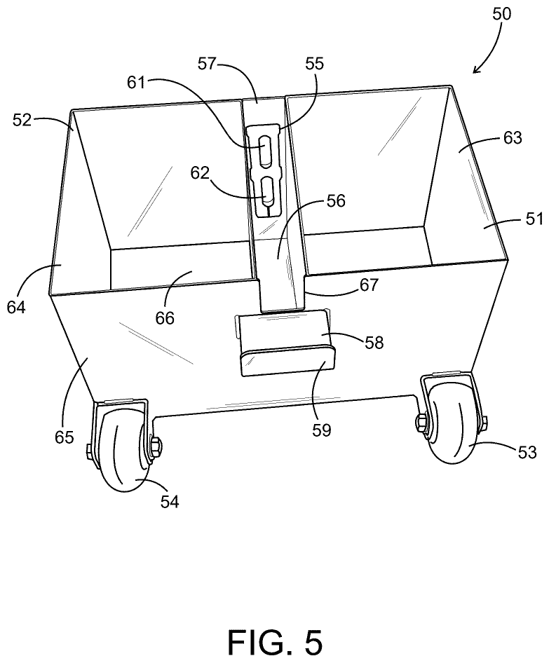

As seen in FIG. 5, the caster bucket 50 has a right bucket holder 51 and a left bucket holder 52. The right bucket holder 51 has a right side defined at a right panel 63. The left bucket holder 52 has a left side defined by a left panel 64. The caster bucket 50 also has a rear panel 65 opposite a front panel 57. The caster bucket also has a caster bucket bottom panel 66. Thus, the caster bucket 50 is formed as a metal box that has a middle slot 56. The middle slot 56 is defined between a pair of metal plates such that the front panel 57 has an opening plate 55 with an upper bucket opening 61 and a lower bucket opening 62. The middle slot 56 extends to a rear panel back notch 67 formed on the rear panel 65. The rear panel back notch 67 extends to a back bracket 58. The back bracket 58 extends rearwardly and has an upwardly extending back bracket tab 59. The caster bucket 50 has a right bucket wheel 53 and a left bucket wheel 54.

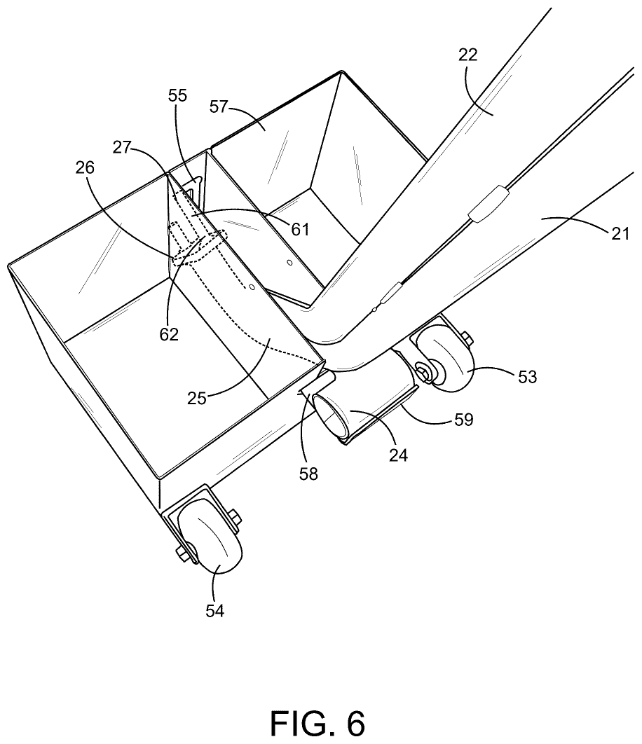

As seen in FIG. 6, the lifting lever handle 21 and bending plate 22 fit into the middle slot 56 such that the first lifting prong 26 extends through the lower bucket opening 62, and the second lifting prong 27 extends through the upper bucket opening 61. The riser 25 fits in the slot so that the fulcrum foot 24 rests on the back bracket 58 and a back bracket tab 59. Polling downwardly on the lifting lever handle 21 tilts the caster bucket 52 right on the right bucket wheel 53 and the left bucket wheel 54. This allows the user to use the lifting lever handle as a hand truck handle. The lifting lever handle 21 can also be stored in the caster bucket 50 when not in use as the caster bucket 50 supports the lifting lever handle 21 in an upright position. The fulcrum foot 24 engages the caster bucket 50, and the first lifting prong and second lifting prong engage the caster bucket 50 so that the lifting lever handle 21 doesn't slip out of the middle slot 56.

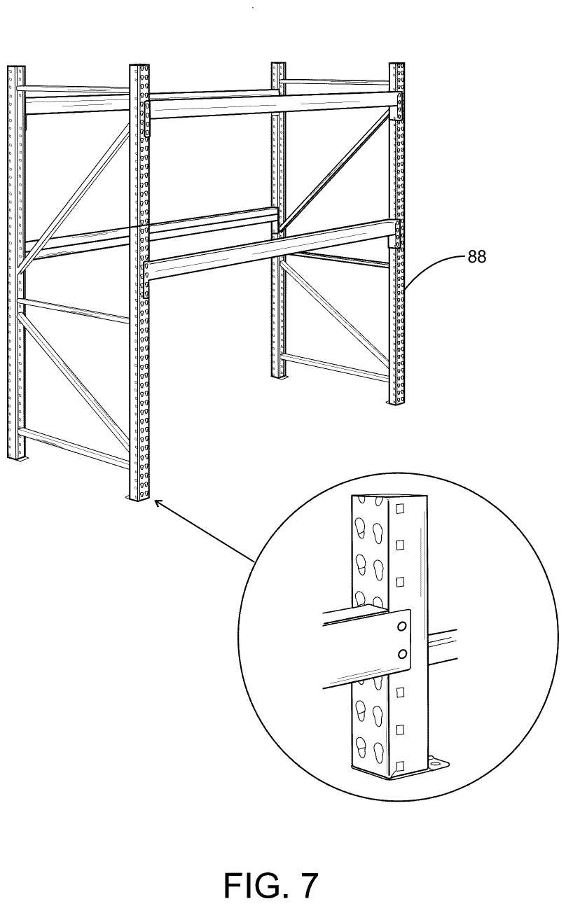

As seen in FIGS. 7 and 8, the rack 88 is typically resting on a floor and when unloaded can be moved. The rack 88 is part of a rack system 80. The rack 88 has a rack leg 86. The rack leg 86 has openings along a front side and rear side and the openings have a rectangular profile 87. A lower retainer opening 81 receives a caster lower tine 36 and an upper retainer opening 82 receives a caster upper tine 35 when the rack crossbeam 85 is raised using the lifting lever 20. The caster upper tine 35 passes through a front rectangular profile 87 and a rear rectangular profile of the rack leg 86. The caster upper tine 35 extends completely through the rack leg 86. The caster lower tine 36 similarly extends completely through the rack leg 86 through a front rectangular profile 87 and a rear rectangular profile. The tine support 37 supports the caster lower tine 36 and the caster upper tine 35. The tine rib 48 is welded to the caster platform 31 and thus retains the stability of the tine support 37. The eccentric loading of the rack leg 86 on the tines binds the pair of times to the rack leg openings, namely the lower retainer opening 81 and the upper retainer opening 82. The caster 30 tilts when loaded downwardly by the rack leg 86 such that the rack leg 86 is connected to the caster 30 by eccentric binding.

As seen in FIG. 8, the caster 30 is about to be inserted into the rack leg 86. The rack foot 83 is thus raised above the ground and the procedure is repeated with the other rack legs 86. The shelf mount openings 89 may also receive the rack crossbeam 85 and the rack crossbeam 85 is preferably mounted to the rectangular profiles 87 of the rack leg openings of the rack leg 86.

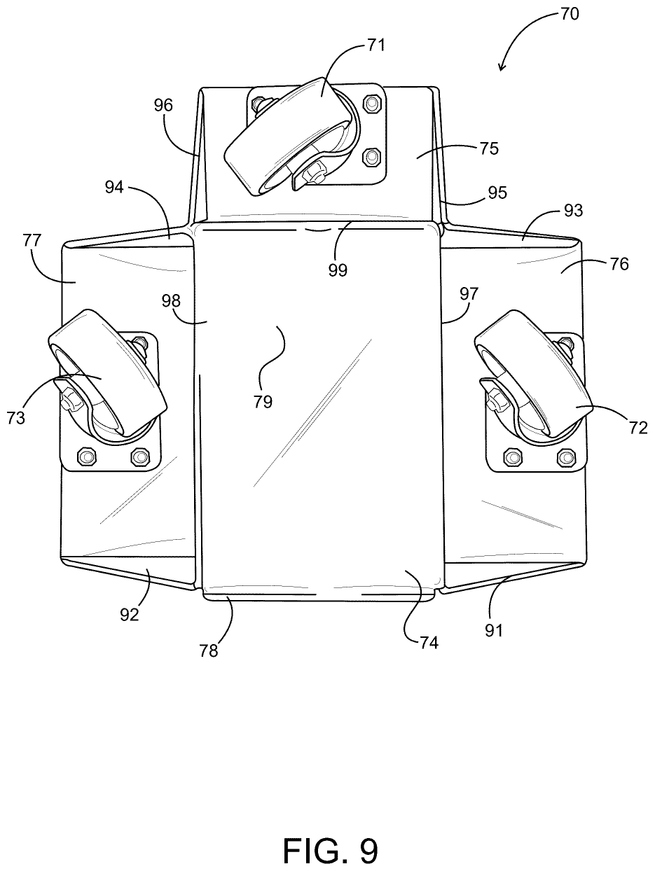

As seen in FIG. 9, when certain rectangular profiles 87 of the rack leg openings are not accessible, a scoop caster 70 can be used instead of the caster 30. The scoop caster 70 preferably includes a first scoop caster wheel 71, a second scoop caster wheel 72, and a third scoop caster wheel 73. The first scoop caster wheel 71, the second scoop caster wheel 72, and the third scoop caster wheel 73 support a scoop caster platform 74. The scoop caster platform 74 supports the rack foot 83. The first scoop caster wheel 71 is mounted in the first wheel cavity 75, and the second scoop caster wheel 72 is mounted in the second wheel cavity 76. The third scoop caster wheel 73 is mounted in the third we'll cavities 77. The scoop caster platform 74 has a scoop caster platform rear portion 79 which receives the rack leg 86. The platform 78 has a front opening so that when the rack leg 86 is lifted slightly above the ground, the scoop caster 70 can slide underneath the rack leg.

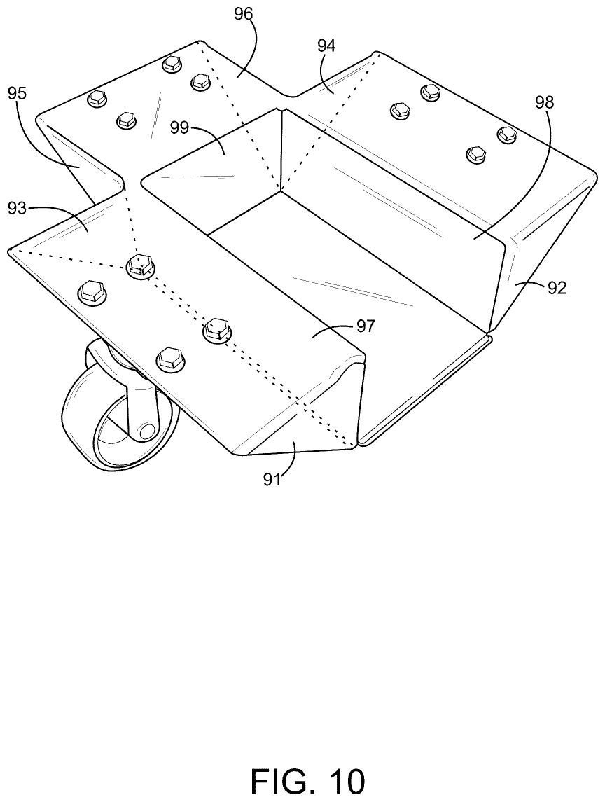

As seen in FIG. 10, the scoop caster platform 76 has a variety of different sidewalls that provide a structure to maintain resistance against bending forces. The first wheel cavity has a first wheel cavity left sidewall 95 parallel to a first wheel cavity right sidewall 96. The second wheel cavity has a second wheel cavity rear sidewall 93 opposite a second wheel cavity front sidewall 91. The third wheel cavity has a third wheel cavity front sidewall 92 opposite a third wheel cavity rear sidewall 94. The first wheel cavity proximal sidewall extends upwardly from the platform 78 and the second wheel cavity proximal sidewall extends upwardly from the platform 78. The third wheel cavity proximal sidewall 98 extends upwardly from the platform 78. The first wheel cavity proximal sidewall 99 extends between the first wheel cavity left sidewall 95 and the first wheel cavity right sidewall 96. The second wheel cavity proximal sidewall 97 extends between the second wheel cavity rear sidewall 93 and the second wheel cavity front sidewall 91. The third wheel cavity proximal sidewall 98 extends between the third wheel cavity rear sidewall 94 and the third wheel cavity front sidewall 92.

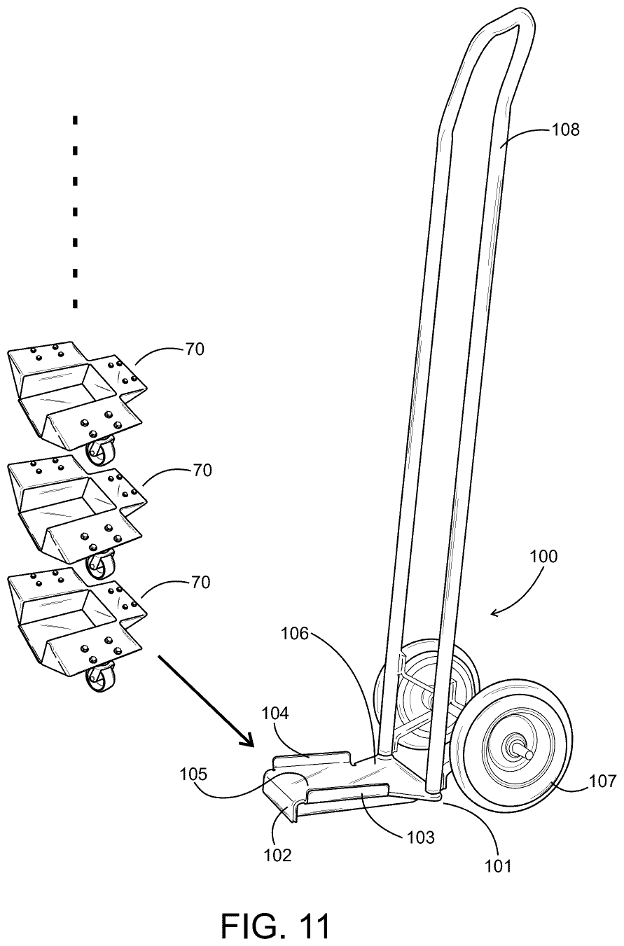

As seen in FIG. 11, a hand truck can be formed as a scoop caster hand truck 100. The scoop caster handtruck has a handtruck handle 108 actuating a lifter plate. The lifter plate 101 has a first lifter plate rail 104 and a second lifter plate rail 103. The lifter plate 101 also has a lifter plate front support 102. The lifter plate further includes a lifter plate retainer channel 105. The scoop casters 70 stacked on top of the lifter plate retainer channel 105. The lifter plate 101 also has a lifter plate connection 106 between the handtruck handle 108 and the lifter plate retainer channel 105. The handtruck wheel 107 is behind the lifter plate 101 and supports the lifter plate 101 when the lifter plate 101 tilts upwardly. The first wheel cavity and the first wheel fits between the handtruck wheels when the scoop caster is loaded to the scoop caster handtruck. The scoop casters can be stacked on top of each other and rest against the handtruck handle during transport.

1. A rack mover system comprising:
a. a caster, wherein the caster has a tine support extending upwardly above a caster platform, wherein the caster platform receives a caster wheel, wherein the tine support supports a pair of tines extending laterally from the tine support, wherein the pair of tines include a caster upper tine and a caster lower tine; and
b. a rack having a rack leg, wherein the caster upper tine is configured to extend into the rack leg at an upper retainer opening, wherein the caster lower tine is configured to extend into the rack leg at a lower retainer opening.

2. The rack mover system of claim 1, further including a caster swivel, wherein the caster swivel receives the caster wheel on a wheel axle, and wherein the caster swivel is mounted to the caster platform.

3. The rack mover system of claim 2, further including a lifting lever, wherein the lifting lever has a prong plate with a first lifting prong and a second lifting prong, wherein the first lifting prong and the second lifting prong are configured to lift the rack leg at a rack crossbeam.

4. The rack mover system of claim 3, further including a caster bucket, wherein the caster bucket has a lifting lever slot, wherein the lifting lever slot receives the lifting lever, wherein the lifting lever is configured to bias the caster bucket to roll on a right bucket wheel and a left bucket wheel when a user pulls back on the lifting lever, wherein the right bucket wheel and the left bucket wheel are mounted to the caster bucket.

5. The rack mover system of claim 4, wherein the lifting lever slot is a middle slot formed between the right bucket holder and the left bucket holder.

6. The rack mover system of claim 3, wherein the lifting lever further includes a bending plate, wherein the bending plate is welded above the lifting lever handle, wherein the bending plate is parallel to the lifting lever handle, wherein the bending plate extends from the lifting lever handle to a riser.

7. The rack mover system of claim 3, wherein the first lifting prong is distal to the second lifting prong, wherein the first lifting prong is shorter than the second lifting prong.

8. The rack mover system of claim 1, further including a scoop caster, wherein the scoop caster has a first scoop caster wheel, a second scoop caster wheel, and a third scoop caster wheel, wherein the first scoop caster wheel is mounted in a first wheel cavity, wherein the second scoop caster wheel is mounted in a second wheel cavity, wherein the third scoop caster wheel is mounted in a third wheel cavity, and further including a scoop caster platform formed between the third wheel cavity and the second wheel cavity, wherein the first wheel cavity is adjacent to the second wheel cavity and the third wheel cavity.

9. The rack mover system of claim 8, wherein the first wheel cavity is formed between a first wheel cavity right sidewall and a first wheel cavity left sidewall, wherein the second wheel cavity is formed between a second wheel cavity rear sidewall and a second wheel cavity front sidewall, wherein the third wheel cavity is formed between a third wheel cavity rear sidewall and a third wheel cavity front sidewall, wherein the scoop caster platform is formed between a third wheel cavity proximal sidewall, a second wheel cavity proximal sidewall, and a first wheel cavity proximal sidewall, wherein the first wheel cavity proximal sidewall defines a proximal sidewall of the first wheel cavity, wherein the second wheel cavity proximal sidewall defines a proximal sidewall of the second wheel cavity, wherein the third wheel cavity proximal sidewall defines a proximal sidewall of the third wheel cavity.

10. The rack mover system of claim 9, a further including a scoop caster hand truck, wherein the scoop caster handtruck has a handtruck handle for lifting a lifter plate, wherein the lifter plate has a first lifter plate rail and a second lifter plate rail, wherein the first lifter plate rail and the second lifter plate rail define a lifter plate retainer channel along the lifter plate, wherein the lifter plate further includes a lifter plate front support, wherein the lifter plate front support is formed as an extending edge.

11. The rack mover system of claim 10, further including a caster swivel, wherein the caster swivel receives the caster wheel on a wheel axle, and wherein the caster swivel is mounted to the caster platform.

12. The rack mover system of claim 11, further including a lifting lever, wherein the lifting lever has a prong plate with a first lifting prong and a second lifting prong, wherein the first lifting prong and the second lifting prong are configured to lift the rack leg at a rack crossbeam.

13. The rack mover system of claim 12, further including a caster bucket, wherein the caster bucket has a lifting lever slot, wherein the lifting lever slot receives the lifting lever, wherein the lifting lever is configured to bias the caster bucket to roll on a right bucket wheel and a left bucket wheel when a user pulls back on the lifting lever, wherein the right bucket wheel and the left bucket wheel are mounted to the caster bucket.

14. The rack mover system of claim 13, wherein the lifting lever slot is a middle slot formed between the right bucket holder and the left bucket holder.

15. The rack mover system of claim 14, wherein the lifting lever further includes a bending plate, wherein the bending plate is welded above the lifting lever handle, wherein the bending plate is parallel to the lifting lever handle, wherein the bending plate extends from the lifting lever handle to a riser.

16. The rack mover system of claim 15, wherein the first lifting prong is distal to the second lifting prong, wherein the first lifting prong is shorter than the second lifting prong.
